(19) United States
(12) Patent Application Publication
(10) Pub. No.: US 2012/0202509 A1
(43) Pub. Date: Aug. 9, 2012

(54) METHOD AND APPARATUS FOR ALLOCATING RANGING CODES IN COMMUNICATION SYSTEM

(75) Inventors: Shuang Feng HAN, Suwon-si (KR); Su-Ryong JEONG, Suwon-si (KR); Chi-Woo LIM, Suwon-si (KR)

(73) Assignee: SAMSUNG ELECTRONICS CO. LTD., Suwon-si (KR)

(21) Appl. No.: 13/367,868

(22) Filed: Feb. 7, 2012

(30) Foreign Application Priority Data
Feb. 8, 2011 (KR) 10-2011-0010887

(51) Int. Cl. H04W 72/04

(52) U.S. Cl. 455/450

(57) ABSTRACT

A method of allocating ranging codes by a macro base station in a communication system is provided. The method includes broadcasting information related to adjacent femto base stations, receiving a ranging request including class information indicating a degree of a strength of interference of an adjacent macro base station from a terminal, and allocating one of ranging codes included in a code subset dedicated to a corresponding class to the terminal, the ranging codes being allocatable to only terminals in a class indicated by the class information.

### PRIORITY

This application claims priority under 35 U.S.C. §119(a) of a Korean patent application filed on Feb. 8, 2011 in the Korean Industrial Property Office and assigned Serial No. 10-2011-0010887, the entire disclosure of which is hereby incorporated reference.

### BACKGROUND OF THE INVENTION

1. Field of the Invention

The present invention relates to a method and an apparatus for allocating ranging codes in a communication system. More particularly, the present invention relates a method and an apparatus for ranging so as to reduce an influence of interference generated by a communication between femto base stations in a network in which a plurality of femto base stations are installed in a service region of a macro base station.

2. Description of the Related Art

A communication system has been developed so as to provide various high-speed mass data services to terminals. To this end, an increase of an entire system capacity and the provision of a service to a shadow region are the important factors affecting the improvement of a quality of the service in the communication system. There are various schemes for providing a service to a shadow region in the communication system, and a representative scheme is a scheme using a femto base station.

The femto base station is a base station having a relatively very small resource capacity and provides a communication service to a small number of terminals existing in a femto cell region, which is a small communication region, such as an independent office, a residential area, and a building, differently from a general base station (hereinafter, referred to a “macro base station”).

In the meantime, a ranging operation, which adjusts a time and power between transmission/reception devices is very important in the communication system. In this case, when it is assumed that a network includes a plurality of femto base stations installed in a service region of a macro base station, there is a problem in that a terminal accessing the macro base station and performing the ranging operation within the network is considerably affected by an interference generated by the transmission/reception of a signal between the femto base stations.

Therefore, a need exists for a system and method for performing transmission and reception of a signal between femto base stations without the inconvenience of interfering with a ranging operation.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus for ranging so as to reduce an influence of interference generated by a communication between femto base stations in a network in which a plurality of femto base stations are installed in a service region of a macro base station.

Another aspect of the present invention is to provide a method and an apparatus for ranging, which classifies classes indicating a strength of interference of an adjacent femto base station according to a position of a terminal and uses allocatable ranging codes for each classified class.

In accordance with an aspect of the present invention, a method of allocating ranging codes by a macro base station in a communication system is provided. The method includes broadcasting information related to adjacent femto base stations, receiving a ranging request including class information indicating a degree of a strength of interference of an adjacent macro base station from a terminal, and allocating one of ranging codes included in a code subset dedicated to a corresponding class to the terminal, the ranging codes being allocatable to only terminals in a class indicated by the class information.

In accordance with another aspect of the present invention, a method of allocating ranging codes by a femto base station in a communication system is provided. The method includes receiving information related to adjacent femto base stations including information indicating a second class dedicated code subset from a macro base station, and in a case where information indicating that the macro base station is performing a ranging with a first terminal in a second class, which indicates that a strength of interference of an adjacent macro base station is high, is received from the macro base station, when a ranging request is received from a second terminal, allocating one of remaining ranging codes allocatable by the femto base station, except for ranging codes included in the second class dedicated code subset, to the second terminal. The second class dedicated code subset is a part of the ranging codes which can be allocated in the adjacent femto base stations located in a service region of the macro base station.

In accordance with another aspect of the present invention, a method of allocating ranging codes by a terminal in a communication system is provided. The method includes accessing a service region of a macro base station and receiving information related to adjacent femto base stations from the macro base station, determining a first distance between the macro base station and the terminal and a sum of a second distance between an adjacent femto base station using a ranging channel identical to that of the macro base station and the terminal and a threshold value, examining if the first distance is larger than the sum, when the first distance is larger than the sum as a result of the examination, classifying the terminal into a second class indicating that a strength of interference from an adjacent macro base station is high, when the first distance is less than the sum as a result of the examination, classifying the terminal into a first class indicating that a strength of interference from an adjacent macro base station is low, and including class information on the terminal in a ranging request and transmitting the information when the ranging request is made to the macro base station.

In accordance with another aspect of the present invention, a macro base station for allocating ranging codes in a communication system is provided. The macro base station includes a transmitter for broadcasting information related to adjacent femto base stations, a receiver for receiving a ranging request including class information indicating a degree of a strength of interference of an adjacent macro base station from a terminal, and a ranging code allocator for allocating one of ranging codes allocatable only to terminals in a class indicated by the class information and included in a code subset dedicated to a corresponding class.

In accordance with another aspect of the present invention, a femto base station for allocating ranging codes in a communication system is provided. The femto base station includes a receiver for receiving information related to adjacent femto base stations including information indicating a second class dedicated code subset from a macro base station, a receiver for receiving information indicating that the macro base station is performing a ranging with a first terminal in a second class, which indicates that a strength of interference of an adjacent macro base station is high, from the macro base station and a ranging request from a second terminal, a ranging code allocator for allocating one of remaining ranging codes allocatable by the femto base station, except for ranging codes included in the second class dedicated code subset, to the second terminal, wherein the second class dedicated code subset is a part of the ranging codes which can be allocated in the adjacent femto base stations located in a service region of the macro base station.

In accordance with another aspect of the present invention, a terminal for receiving an allocation of ranging codes in a communication system is provided. The terminal includes a receiver for receiving information related to adjacent femto base stations from a macro base station after accessing a service region of the macro base station, a class determiner for determining a first distance between the macro base station and the terminal and a sum of a second distance between an adjacent femto base station using a ranging channel identical to that of the macro base station and the terminal and a threshold value, for examining if the first distance is larger than the sum, for classifying the terminal into a second class indicating that a strength of interference from an adjacent macro base station is high when the first distance is larger than the sum as a result of the examination, and for classifying the terminal into a first class indicating that a strength of interference from an adjacent macro base station is low when the first distance is less than the sum as a result of the examination, and a transmitter for including class information on the terminal in a ranging request and transmitting the information when the ranging request is made to the macro base station.

Accordingly, the present invention classifies the terminal into a class among the classes indicating the strength of the interference of the femto base station by using a distance between the terminal and the macro base station and a distance between the terminal and the femto base station and performs the ranging using the ranging code divided for each classified class within the network in which the plurality of femto base stations are installed within the service region of the macro base station, so that it is effectively possible to reduce an influence of the interference generated by the femto base stations.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating an example of a network including a macro base station and femto base stations installed in a service region of the macro base station according to an exemplary embodiment of the present invention;

FIG. 2 is a diagram illustrating ranging codes classified and set for each class of a terminal according to an exemplary embodiment of the present invention;

FIG. 3 is a diagram illustrating an example of a method of using ranging codes classified for each class according to an exemplary embodiment of the present invention;

FIG. 4 is a flowchart illustrating an operation of a macro base station according to an exemplary embodiment of the present invention;

FIG. 5 is a flowchart illustrating an operation of a femto base station according to an exemplary embodiment of the present invention;

FIG. 6 is a flowchart illustrating an operation of a terminal according to an exemplary embodiment of the present invention;

FIG. 7 is a diagram schematically illustrating a base station according to an exemplary embodiment of the present invention; and

FIG. 8 is a diagram schematically illustrating a terminal according to an exemplary embodiment of the present invention.

Throughout the drawings, it should be noted that like reference numbers are used to depict the same or similar elements, features, and structures.

### DETAILED DESCRIPTION OF THE EXEMPLARY EMBODIMENT

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The exemplary embodiments of the present invention include a method and an apparatus for ranging a terminal accessing a macro base station in a network in which a plurality of femto base stations (hereinafter, referred to as “adjacent femto base stations”) are installed within a service region of a macro base station.

More specifically, prior to making a ranging request, a terminal accessing the macro base station decides a class indicating a strength of interference between the terminal and adjacent femto base stations by using a position of the terminal and positions of the femto base stations located within the service region of the macro base station. That is, the terminal decides a class to which the terminal corresponds between class 1 indicating that interference with the adjacent femto base stations is low and class 2 indicating that interference with the adjacent femto base stations is high. In the present invention, two types of classes have been exemplified for description, but it is a matter of course that the class of a corresponding terminal may be classified in different forms.

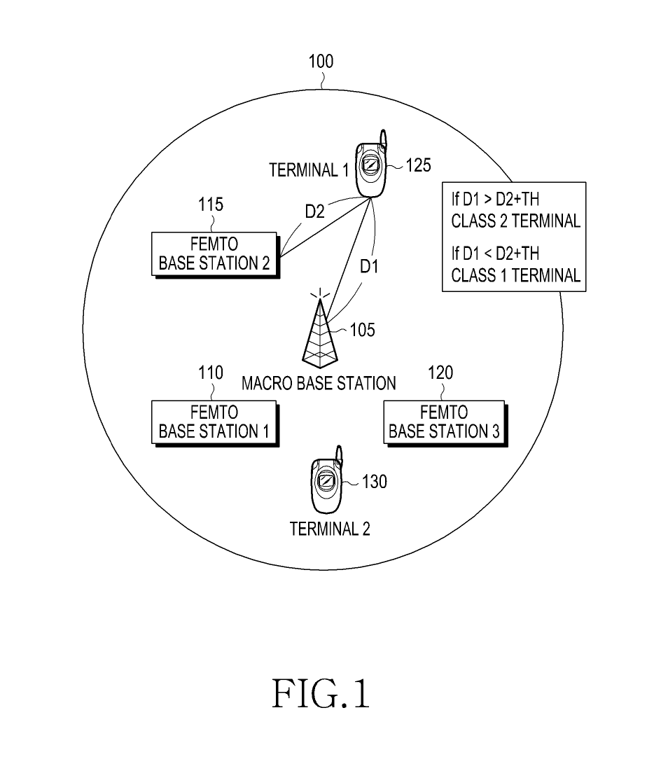

FIGS. 1 through 8, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

Hereinafter, an operation of deciding a class of the terminal by the terminal itself according to an exemplary embodiment of the present invention will be described with reference to FIG. 1.

FIG. 1 is a diagram illustrating an example of a network including a macro base station and femto base stations installed in a service region of the macro base station according to an exemplary embodiment of the present invention. In the present embodiment, the present invention will be described based on a example in which three femto base stations 1 to 3 are installed within a service region 100 of the macro base station.

Referring to FIG. 1, the network includes a macro base station 105, femto base stations, i.e. first femto base station 110, second femto base station 115, and third femto base station 120, located within the service region 100 of the macro base station, and a first terminal 125 and a second terminal 130 accessing the macro base station 105.

The macro base station 105 has already recognized ranging codes and ranging channels used in a ranging operation of each of the first femto base station 110, the second femto base station 115, and the third femto base station 120. In this case, the macro base station 105 selects a femto base station, e.g. the second femto base station 115, which uses a ranging channel identical to that of the macro base station 105, from among the first femto base station 110, the second femto base station 115, and the third femto base station 120 in order to reduce an overhead in the ranging operation.

The macro base station 105 broadcasts information related to the adjacent femto base stations. The information related to the adjacent femto base stations contains a cell identifier, a position, a ranging channel, and a ranging code of each of the first femto base station 110, the second femto base station 115, and the third femto base station 120, and information indicating the femto base station uses a ranging channel identical to that of the macro base station 105.

The macro base station 105 broadcasts a distance threshold value used for deciding a class which is used for making a decision if a corresponding terminal is located in a position in which interference generated due to a communication with the adjacent femto base stations can be ignored.

The first terminal 125 and the second terminal 130 accessing the macro base station 105 decide a class of the corresponding terminal by using the threshold value before making a ranging request, respectively.

First, a case in which the first terminal 125 decides a class will be described. The first terminal 125 decides a class by using its own position acquired using a Global Positioning System (GPS) included therein, and a GPS position of the second femto base station 115 using the ranging channel identical to that of the macro base station 105 acquired from the information related to the adjacent femto base stations broadcasted from the macro base station 105 and a position of the macro base station 105. In this case, the position of the macro base station 105 is acquired using a strength of a reference signal broadcasted by the macro base station 105. More specifically, the first terminal 125 determines a distance D1 between the first terminal 125 and the macro base station 105 by using its own position and the strength of the reference signal. The first terminal 125 determines a distance D2 between the first terminal 125 and the second femto base station 115 by using its own position and the position of the decided second femto base station 115.

The first terminal 125 determines a sum of the determined distance D2 and the threshold value TH. The first terminal 125 compares the distance D1 and the sum. When the distance D1 is larger than the sum, the first terminal 125 classifies itself into class 2 indicating that interference with the adjacent femto base station is high.

A case in which the second terminal 130 decides a class will be described. The second terminal 130 decides a class by using its own position acquired using a GPS included therein, and a GPS position of the second femto base station 115 using the ranging channel identical to that of the macro base station 105 acquired from the information related to the adjacent femto base stations broadcasted from the macro base station 105 and a position of the macro base station 105. In this case, the position of the macro base station 105 is acquired using a strength of a reference signal broadcasted by the macro base station 105. More specifically, the second terminal 130 determines a distance D1′ between the second terminal 130 and the macro base station 105 by using its own position and the strength of the reference signal. The second terminal 130 determines a distance D2′ between the second terminal 130 and the second femto base station 115 by using its own position and the position of the decided second femto base station 115.

The second terminal 130 determines a sum of the determined distance D2′ and the threshold value TH. The second terminal 130 compares the distance D1′ and the sum (D2′+TH). When the distance D1′ is less than the sum, the second terminal 130 classifies itself into class 1 indicating that interference with the adjacent femto base station is low.

As described above, when the terminal accessing the macro base station 105 decides its own class, the terminal transfers the ranging request containing information on the decided class to the macro base station when making the ranging request to the macro base station 105, so that the terminal is allocated ranging codes configured in correspondence to the decided class and performs the ranging operation.

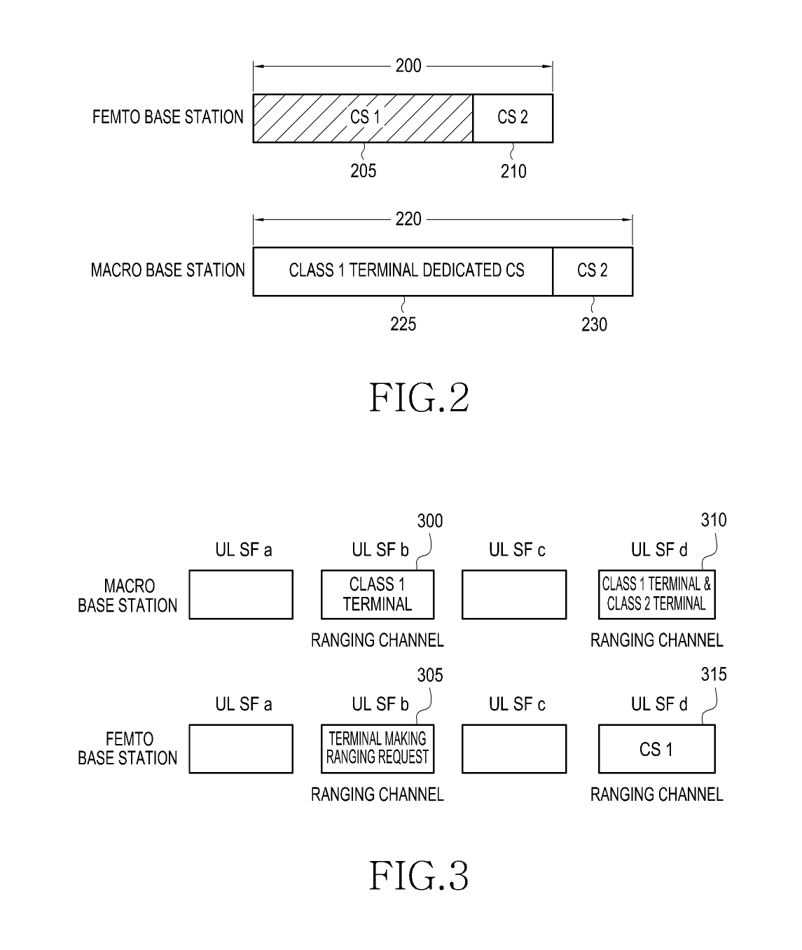

FIG. 2 is a diagram illustrating ranging codes set for each class of the terminal according to an exemplary embodiment of the present invention.

Referring to FIG. 2, the macro base station divides entire ranging codes allocatable for the ranging operation into a class 1 dedicated Code Subset (CS) 225 indicating ranging codes that are dedicatedly allocated to the terminals classified into class 1 and CS2 230 indicating a class 2 dedicated CS 230 indicating ranging codes that are dedicatedly allocated to the terminals classified into class 2. In this case, the macro base station configures the CS2 230 with some of the entire ranging codes 220 allocatable by the adjacent femto base stations.

The adjacent femto base station using the ranging channel identical to that of the macro base station has recognized the ranging codes, i.e. CS2 210, corresponding to the CS2 230, which is dedicatedly allocated to the terminals classified into class 2 by the macro base station, among the entire allocatable ranging codes 200 for the ranging operation. The CS2 230 is included in the information related to the adjacent femto base stations broadcasted by the macro base station and broadcasted.

When an adjacent base station, which recognizes that it uses the ranging channel identical to the macro base station through the information related to the adjacent base stations, receives a message indicating that the macro base station is performing the ranging with the terminal of class 2 from the macro base station, the adjacent femto base station makes a decision not to use ranging codes included in the CS2 210 when performing the ranging with the terminal accessing the adjacent femto base station itself and transmits a message indicating the decision to the terminals accessing the adjacent femto base station itself

FIG. 3 is a diagram illustrating an example of a method of using ranging codes classified for each class according to an exemplary embodiment of the present invention.

Referring to FIG. 3, it is assumed that the macro base station uses a total of four uplink service flows. In this case, it is assumed that the macro base station uses an uplink service flow b and an uplink service flow d as a ranging channel.

First, a case in which the ranging operation is performed in the uplink service flow b will be described. It is assumed that the macro base station receives a ranging request containing information indicating that a class of a certain terminal is class 1 from the certain terminal in the uplink service flow b. The macro base station allocates one of the ranging codes included in the class 1 terminal dedicated CS 220 to the terminal 300 of class 1 and performs the ranging with the terminal of class 1. In this case, the femto base station using the ranging channel identical to that of the macro base station allocates one of the ranging codes 200, which can be allocated by the femto base station itself, to the terminal 305 making a ranging request to the femto base station and performs the ranging with the terminal

First, a case in which the ranging is performed in the uplink service flow d will be described.

It is assumed that the macro base station receives a ranging request including information indicating that a class of a certain terminal is class 1 from the certain terminal and a ranging request including information indicating that a class of another terminal is class 2 from the another terminal. The macro base station allocates one of the ranging codes included in the class 2 terminal dedicated CS 230 to the terminal 310 of class 2 and performs the ranging with the terminal of class 2. In this case, when the femto base station using the ranging channel identical to that of the macro base station receives information indicating that the macro base station is performing the ranging with the terminal of class 2 from the macro base station, the femto base station allocates one of the ranging codes included in the CS1 205 to the terminal 315 which makes a ranging request to the femto base station and performs the ranging with the terminal. The macro base station may broadcast the information indicating that the macro base station is performing the ranging with the terminal of class 2 or transmit the information only to the femto base station using the ranging channel identical to that of the macro base station. That is, the femto base station using the ranging channel identical to that of the macro base station allocates one of the remaining ranging codes, except for the ranging codes included in the CS2 230 including the ranging codes allocatable the macro base station, to the terminal making the ranging request to the femto base station. Accordingly, the femto base station may allocate a ranging code which is not identical to the ranging code allocated by the macro base station.

Further, the macro base station allocates one of the ranging codes included in the class 1 terminal dedicated CS 220 to the terminal 310 of class 1 and performs the ranging with the terminal 310 of class 1. In this case, since the femto base station using the ranging channel identical to that of the macro base station has recognized that the macro base station is performing the ranging with the terminal of class 2, the femto base station allocates one of the ranging codes included in the CS1 205 to the terminal making the ranging request to the femto base station and performs the ranging with the terminal.

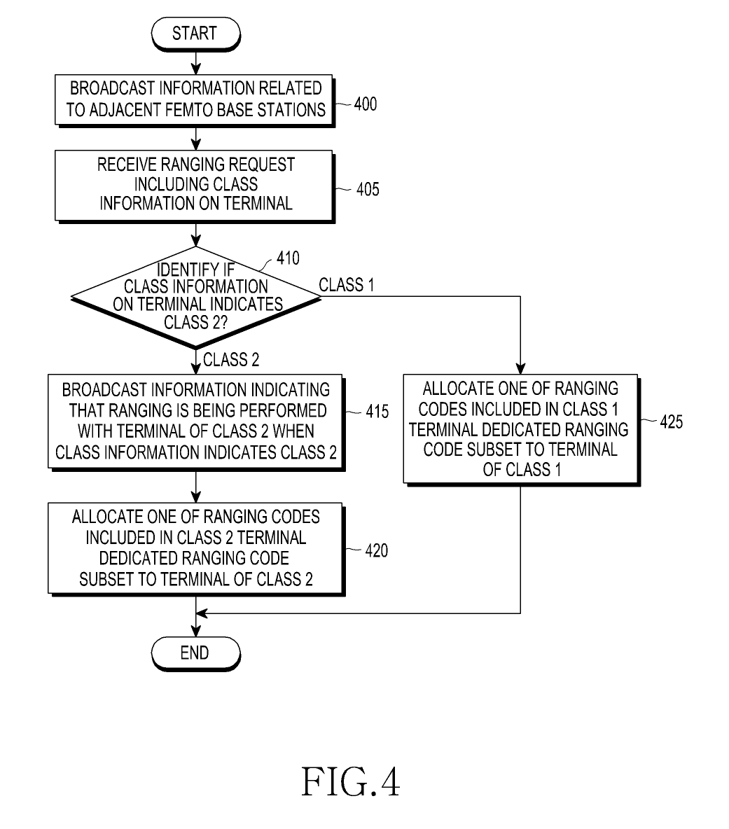

FIG. 4 is a flowchart illustrating an operation of the macro base station according to an exemplary embodiment of the present invention.

Referring to FIG. 4, the macro base station broadcasts information related to adjacent femto base stations in step 400 and proceeds to step 405. The information related to adjacent femto base stations contains a cell identifier, a position, a ranging channel, and a ranging code of each of the adjacent femto base stations located within a service region of the macro base station, and information indicating that the femto base station is a femto base station using the ranging channel identical to that of the macro base station. In this case, the information related to adjacent femto base stations further contains information indicating the class 2 dedicated CS of each of the adjacent femto base stations.

In step 405, the macro base station receives a ranging request including information on a class of a terminal from a terminal accessing its own service region and proceeds to step 410.

In step 410, the macro base station identifies if the information on the class of the terminal indicates class 2. When it is identified that the information on the class of the terminal indicates class 2, the macro base station broadcasts information indicating that the macro base station is performing the ranging with the terminal of class 2 in step 415, and proceeds to step 420. In this case, the macro base station may transmit the information indicating that the macro base station is performing the ranging with the terminal of class 2 only to a femto base station using a ranging channel identical to that of the macro base station.

In step 420, the macro base station allocates one of ranging codes included in a class 2 dedicated CS to the terminal.

In contrast, when it is identified at step 410 that the information on the class of the terminal indicates class 1, the macro base station allocates one of ranging codes included in a class 1 terminal dedicated CS to the terminal in step 425.

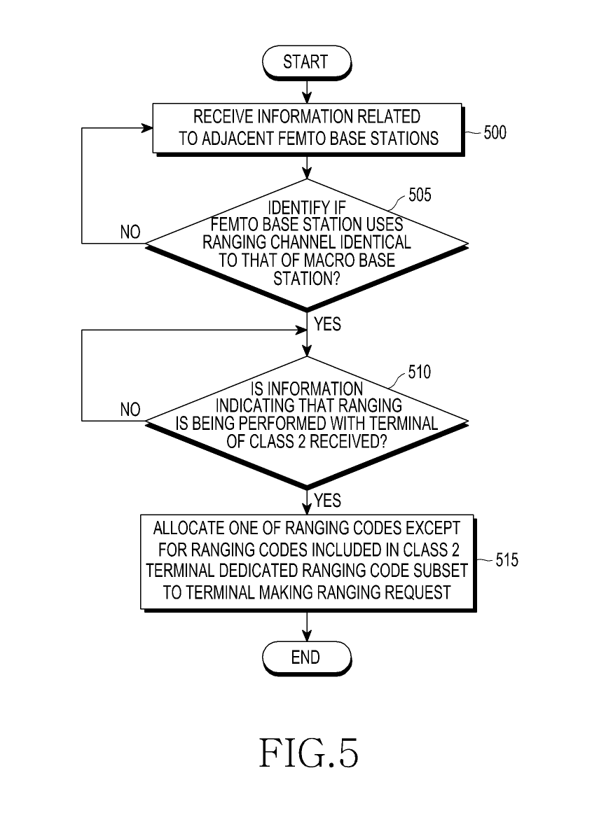

FIG. 5 is a flowchart illustrating an operation of a femto base station according to an exemplary embodiment of the present invention.

Referring to FIG. 5, the femto base station receives the information on the adjacent femto base stations broadcasted from the macro base station in step 500, and proceeds to step 505. The information related to the adjacent femto base stations contains a cell identifier, a position, a ranging channel, and a ranging code of each of the adjacent femto base stations located within a service region of the macro base station, and information indicating that the femto base station is a femto base station using the ranging channel identical to that of the macro base station. In this case, the information related to adjacent femto base stations further contains information indicating the class 2 dedicated CS of each of the adjacent femto base stations.

In step 505, the femto base station identifies if it uses the ranging channel identical to that of the macro base station based on the information indicating that the femto base station is a femto base station using the ranging channel identical to that of the macro base station acquired from the information related to the adjacent femto base stations. When it is identified that the femto base station uses the ranging channel identical to that of the macro base station, the femto base station determines if information indicating that the macro base station is performing the ranging with the terminal of class 2 is received in step 510. When it is determined that the information indicating that the macro base station is performing the ranging with the terminal of class 2 is received, the femto base station allocates one of the ranging codes, except for the ranging codes included in the class 2 terminal dedicated CS, to a terminal transmitting a ranging request when it receives the ranging request from the terminal in step 515.

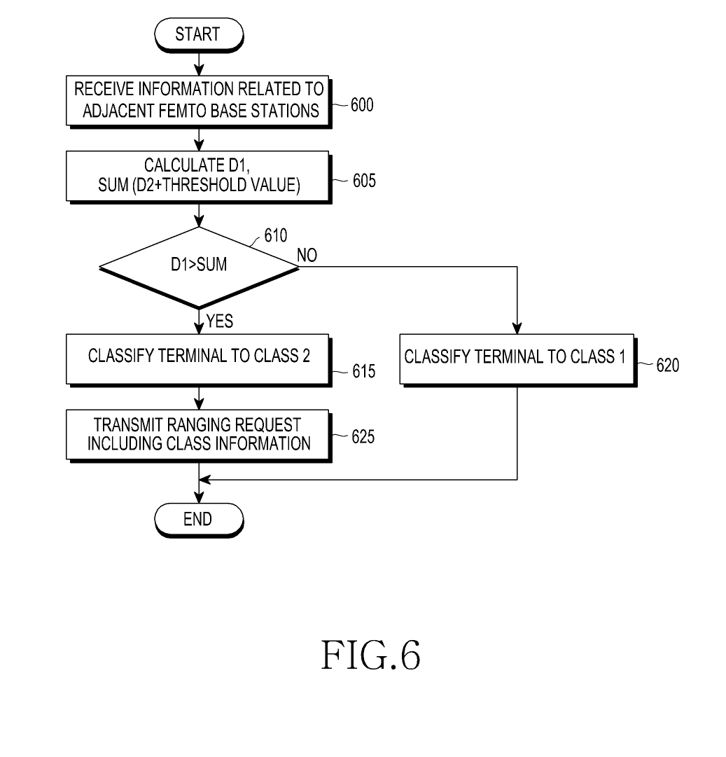

FIG. 6 is a flowchart illustrating an operation of a terminal according to an exemplary embodiment of the present invention.

Referring to FIG. 6, a terminal accessing a service region of a macro base station receives information related to adjacent femto base stations broadcasted from the macro base station in step 600, and proceeds to step 605.

In step 605, the terminal determines a distance D1 between the terminal and the macro base station by using a strength of a reference signal received from the macro base station, and determines a sum of a distance D2 between the terminal and the femto base station by using its own position and a position of the femto base station acquired from the information related to the adjacent femto base stations and a threshold value acquired from the information related to the adjacent femto base station, and proceeds to step 610.

In step 610, the terminal determines if the distance D1 is larger than the sum. When it is determined that the distance D1 is larger than the sum, the terminal classifies its own class into class 2 in step 615, and proceeds to step 625. In contrast, if it is determined in step 610 that the distance D1 is less than the sum, the terminal classifies its own class into class 1 in step 620, and proceeds to step 625. In step 625, the terminal includes information indicating its own class in a ranging request and transmits the information to the macro base station when making the ranging request to the macro base station.

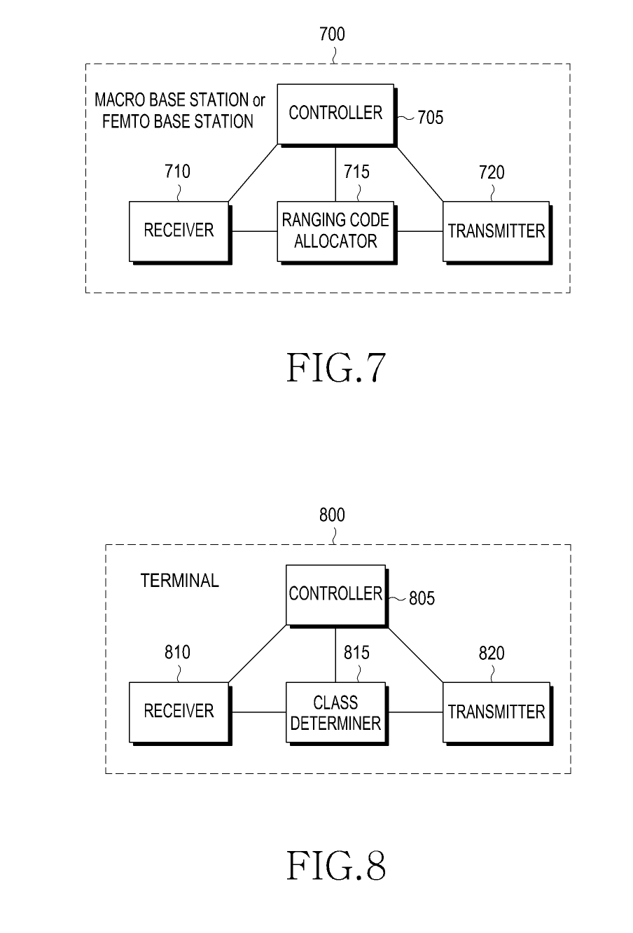

FIG. 7 is a diagram schematically illustrating a base station according to an exemplary embodiment of the present invention.

Referring to FIG. 7, a base station 700 may serve as a macro base station or a femto base station and includes a controller 705, a receiver 710, a ranging code allocator 715, and a transmitter 720.

First, an exemplary case where the base station 700 serves as a macro base station will be described. The transmitter 720 broadcasts information on adjacent femto base stations. The information related to adjacent femto base stations contains a cell identifier, a position, a ranging channel, and a ranging code of each of the adjacent femto base stations located within a service region of the macro base station, and information indicating that the femto base station is a femto base station using the ranging channel identical to that of the macro base station. In this case, the controller 705 controls such that the information related to adjacent femto base stations further contains information indicating the class 2 dedicated CS of each of the adjacent femto base stations.

The receiver 710 receives a ranging request including information on a class of a terminal from the terminal accessing its own service region. The controller 705 identifies if the information on the class included in the ranging request indicates class 2. When it is identified that the information on the class included in the ranging request indicates class 2, the controller 705 broadcasts information indicating that the macro base station is performing the ranging with the terminal of class 2. In this case, the controller 705 controls the transmitter 720 such that the transmitter 720 does not broadcast the information indicating that the macro base station is performing the ranging with the terminal of class 2, but it transmits the information only to a femto base station using a ranging channel identical to that of the macro base station.

The ranging code allocator 715 has already recognized a class 1 dedicated CS and a class 2 dedicated CS among entire ranging codes allocatable according to an instruction of the controller 705. The class 2 dedicated CS is a part of the ranging codes which the adjacent femto base stations can allocate. Further, the adjacent femto base stations have recognized a ranging code corresponding to the class 2 dedicated CS through the broadcasted information on the adjacent femto base stations among the ranging codes which the adjacent femto base stations allocate. When the controller 705 recognizes that the receiver 710 receives a ranging request from the terminal of class 2, the controller 705 controls the ranging code allocator 715 such that one of the ranging codes included in the class 2 dedicated CS is allocated to the terminal When the controller 705 recognizes that the receiver 710 receives a ranging request from the terminal of class 1, the controller 705 controls the ranging code allocator 715 such that one of the ranging codes included in the class 1 dedicated CS is allocated to the terminal.

FIG. 8 is a diagram schematically illustrating a terminal according to an exemplary embodiment of the present invention.

Referring to FIG. 8, a terminal 800 includes a controller 805, a receiver 810, a class determiner 815, and a transmitter 820.

When the terminal 800 accesses a service region of a macro base station, the receiver 810 receives information on adjacent femto base stations broadcasted from the macro base station.

The class determiner 815 determines a distance D1 between the terminal and the macro base station by using a strength of a reference signal received from the macro base station, and determines a sum of a distance D2 between the terminal and the femto base station by using its own position and a position of the femto base station acquired from the information related to the adjacent femto base stations and a threshold value acquired from the information related to the adjacent femto base station according to an instruction of the controller 805.

The controller 805 determines if the distance D1 is larger than the sum. When it is determined that the distance D1 is larger than the sum, the terminal classifies its own class into class 2, and when it is determined that the distance D1 is less than the sum, the terminal classifies its own class into class 1. The controller 805 controls the transmitter 820 such that the transmitter 820 includes information indicating its own class in a ranging request and transmits the information to the macro base station when making the ranging request to the macro base station.

Certain aspects of the present invention can also be embodied as computer readable code on a computer readable recording medium. A computer readable recording medium is any data storage device that can store data which can be thereafter read by a computer system. Examples of the computer readable recording medium include Read-Only Memory (ROM), Random-Access Memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

At this point it should be noted that the exemplary embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the exemplary embodiments of the present invention as described above. Alternatively, one or more processors operating in accordance with stored instructions may implement the functions associated with the exemplary embodiments of the present invention as described above. If such is the case, it is within the scope of the present disclosure that such instructions may be stored on one or more processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present invention can be easily construed by programmers skilled in the art to which the present invention pertains.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of allocating ranging codes by a macro base station in a communication system, the method comprising:
broadcasting information related to adjacent femto base stations;
receiving a ranging request including class information indicating a degree of a strength of interference of an adjacent macro base station from a terminal; and
allocating one of ranging codes included in a code subset dedicated to a corresponding class to the terminal, the ranging codes being allocatable to only terminals in a class indicated by the class information.

2. The method as claimed in claim 1, wherein the class information comprises an indicator indicating one of a first class representing that the strength of the interference of the adjacent macro base station of the terminal is low, and a second class representing that the strength of the interference of the adjacent macro base station of the terminal is high.

3. The method as claimed in claim 2, further comprising allocating one of ranging codes allocatable to only terminals in the second class and included in a second class dedicated code subset to the terminal when the class information comprises the indicator indicating the second class,
wherein the second class dedicated code subset is a part of ranging codes allocatable in the adjacent femto base stations located in a service region of the macro base station.

4. The method as claimed in claim 3, wherein the information related to the adjacent femto base stations comprises:
a cell identifier, a position, a ranging channel, and a ranging code of each of the adjacent femto base stations;
information indicating that the femto base station comprises a femto base station using a ranging channel identical to that of the macro base station; and
information indicating the second class dedicated code subset.

5. A method of allocating ranging codes by a femto base station in a communication system, the method comprising:
receiving information related to adjacent femto base stations including information indicating a second class dedicated code subset from a macro base station; and
in a case where information indicating that the macro base station is performing a ranging with a first terminal in a second class, which indicates that a strength of interference of an adjacent macro base station is high, is received from the macro base station, when a ranging request is received from a second terminal, allocating one of remaining ranging codes allocatable by the femto base station, except for ranging codes included in the second class dedicated code subset, to the second terminal,
wherein the second class dedicated code subset is a part of the ranging codes that can be allocated in the adjacent femto base stations located in a service region of the macro base station.

6. The method as claimed in claim 5, wherein the information related to the adjacent femto base stations comprises a cell identifier, a position, a ranging channel, and a ranging code of each of the adjacent femto base stations, and information indicating that the femto base station is a femto base station using a ranging channel identical to that of the macro base station.

7. A method of allocating ranging codes by a terminal in a communication system, the method comprising:
accessing a service region of a macro base station and receiving information related to adjacent femto base stations from the macro base station;
determining a first distance between the macro base station and the terminal, and a sum of a second distance between an adjacent femto base station using a ranging channel identical to that of the macro base station and the terminal, and a threshold value;
examining if the first distance is larger than the sum;
when the first distance is larger than the sum as a result of the examination, classifying the terminal into a second class indicating that a strength of interference from an adjacent macro base station is high;
when the first distance is less than the sum as a result of the examination, classifying the terminal into a first class indicating that a strength of interference from an adjacent macro base station is low; and
including class information on the terminal in a ranging request and transmitting the information when the ranging request is made to the macro base station.

8. The method as claimed in claim 7, wherein the information related to the adjacent femto base stations comprises:
a cell identifier, a position, a ranging channel, and a ranging code of each of the adjacent femto base stations;
information indicating that the femto base station is a femto base station using a ranging channel identical to that of the macro base station; and
information indicating the second class dedicated code subset.

9. The method as claimed in claim 8, wherein the second class dedicated code subset is a part of ranging codes which can be allocated in the adjacent femto base stations located in a service region of the macro base station.

10. The method as claimed in claim 8, wherein the first distance is determined using a position of the terminal and a position of an adjacent femto base station that uses a ranging channel identical to that of the macro base station, and the second distance is determined using a reference signal received from the macro base station and the position of the terminal, and
the threshold value is received through the information related to the adjacent femto base stations.

11. A macro base station for allocating ranging codes in a communication system, the macro base station comprising;
a transmitter for broadcasting information related to adjacent femto base stations;
a receiver for receiving a ranging request including class information indicating a degree of a strength of interference of an adjacent macro base station from a terminal; and
a ranging code allocator for allocating one of ranging codes allocatable only to terminals in a class indicated by the class information and included in a code subset dedicated to a corresponding class.

12. The macro base station as claimed in claim 11, wherein the class information comprises an indicator indicating one of a first class representing that the strength of the interference of the adjacent macro base station of the terminal is low, and a second class representing that the strength of the interference of the adjacent macro base station of the terminal is high.

13. The macro base station as claimed in claim 12,
wherein the ranging code allocator allocates one of ranging codes allocatable to only terminals in the second class and included in a second class dedicated code subset to the terminal when the class information comprises the indicator indicating the second class, and
wherein the second class dedicated code subset is a part of ranging codes which can be allocated in adjacent femto base stations located in a service region of the macro base station.

14. The macro base station as claimed in claim 13, wherein the information related to the adjacent femto base stations comprises:
a cell identifier, a position, a ranging channel, and a ranging code of each of the adjacent femto base stations;
information indicating that the femto base station is a femto base station using a ranging channel identical to that of the macro base station; and
information indicating the second class dedicated code subset.

15. A femto base station for allocating ranging codes in a communication system, the femto base station comprising;
a receiver for receiving information related to adjacent femto base stations including information indicating a second class dedicated code subset from a macro base station;
a receiver for receiving information indicating that the macro base station is performing a ranging with a first terminal in a second class, which indicates that a strength of interference of an adjacent macro base station is high, from the macro base station and a ranging request from a second terminal;
a ranging code allocator for allocating one of remaining ranging codes allocatable by the femto base station, except for ranging codes included in the second class dedicated code subset, to the second terminal,
wherein the second class dedicated code subset is a part of the ranging codes that can be allocated in the adjacent femto base stations located in a service region of the macro base station.

16. The femto base station as claimed in claim 15, wherein the information related to the adjacent femto base stations comprises at least one of a cell identifier, a position, a ranging channel, and a ranging code of each of the adjacent femto base stations, and information indicating that the femto base station is a femto base station using a ranging channel identical to that of the macro base station.

17. A terminal for receiving an allocation of ranging codes in a communication system, the terminal comprising:
a receiver for receiving information related to adjacent femto base stations from a macro base station after accessing a service region of the macro base station;
a class determiner for determining a first distance between the macro base station and the terminal and a sum of a second distance between an adjacent femto base station using a ranging channel identical to that of the macro base station and the terminal and a threshold value, examining if the first distance is larger than the sum, classifying the terminal into a second class indicating that a strength of interference from an adjacent macro base station is high when the first distance is larger than the sum as a result of the examination, and classifying the terminal into a first class indicating that a strength of interference from an adjacent macro base station is low when the first distance is less than the sum as a result of the examination; and
a transmitter for including class information on the terminal in a ranging request and transmitting the information when the ranging request is made to the macro base station.

18. The terminal as claimed in claim 17, wherein the information related to the adjacent femto base stations comprises a cell identifier, a position, a ranging channel, and a ranging code of each of the adjacent femto base stations, information indicating that the femto base station is a femto base station using a ranging channel identical to that of the macro base station, and information indicating the second class dedicated code subset.

19. The terminal as claimed in claim 18, wherein the second class dedicated code subset is a part of ranging codes which can be allocated in adjacent femto base stations located in a service region of the macro base station.

20. The terminal as claimed in claim 18, wherein the class determiner determines the first distance using a position of the terminal and a position of an adjacent femto base station that uses a ranging channel identical to that of the macro base station, and the second distance using a reference signal received from the macro base station and the position of the terminal, and
receives the threshold value through the information related to the adjacent femto base stations.
